(19) United States
(12) Patent Application Publication
(10) Pub. No.: US 2013/0040160 A1
(43) Pub. Date: Feb. 14, 2013

(54) METHOD FOR MANUFACTURING A PLATE INCLUDING MULTIPLE METAL LAYERS

(71) Applicants: Zoltrix Material (Guangzhou) limited, Panyu (CN); Dongguan Grand Fame Industry, Dongguan City (CN)

(72) Inventors: Chi Hung Kevin LIU, Hong Kong (HK); Chi Hung HO, Hong Kong (HK)

(73) Assignees: Dongguan Grand Fame Industry, Dongguan City (CN); Zoltrix Material (Guangzhou) limited, Panyu (CN)

(21) Appl. No.: 13/651,980

(22) Filed: Oct. 15, 2012

Related U.S. Application Data
(63) Continuation-in-part of application No. 13/277,673, filed on Oct. 20, 2011.

(30) Foreign Application Priority Data
Feb. 1, 2011 (CN) 201110037281.4

(51) Int. Cl. B22D 19/00; B32B 7/08; B32B 15/20; B32B 15/01

(52) U.S. Cl. 428/594; 428/615; 428/636; 428/600; 428/681; 428/658; 428/650; 428/649; 428/666; 428/660; 428/674; 428/680; 164/111

(57) ABSTRACT

A method for manufacturing a plate including multiple metal layers is provided. The method includes: disposing a semi-finished plate formed of a first metal in a mold, wherein a surface of the semi-finished plate is roughened; and injecting a second metal in liquid form onto the roughened surface of the semi-finished plate, so as to form a second metal layer on the semi-finished plate, wherein the second metal in liquid form covers and fills the roughened surface of the semi-finished plate. Not only does the multi-layer metal plate manufactured according to the method have the strength and elasticity of a composite metal, but also increase the joining, bonding or engagement strength between the first and second metal layers without laser welding.

This application is a Continuation-In-Part of U.S. patent application Ser. No. 13/277,673 filed on 20 Oct. 2011, the contents of which are hereby fully incorporated by reference herein for all purposes.

### FIELD OF THE INVENTION

The present invention relates to a method for manufacturing a plate including a metal layer, and more particularly to a method for manufacturing a plate including multiple metal layers.

### BACKGROUND OF THE INVENTION

With the rapid development in consumer electronics, or any product in other industries which need to improve the strength of the joining or bonding strength between two metals, for example: products for house-hold industry, auto-motive industry, or other industries which the products need to be over-molding a plurality of metal layers onto the first metal layer (such as a cover or a plate) to improve the joining or bonding strength between two metals, consumers not only want the products to have good substantial performance, such as processing speed and storage capability in a portable computer or tablet computer and communication transmission in a mobile phone, but also have increasingly higher requirements for their appearance and durability. A metal casing which has pleasing appearance, good strength, and high ductility while being light weight will thus become more and more important to consumer electronic products.

A colorful plastic casing of a conventional electronic product is easily broken by external impact, while a casing of a single metal layer may rust due to environmental factors, or subsequent surface treatment cannot be performed on the casing due to the limitation of material properties. Therefore, multiple metal layers that are rust proof and scratch resistant and have high strength which plastic or single metallic part cannot reach and pleasing appearance are needed to solve the various problems of the single metal layer. However, in the prior art, a casing formed of double metal layers or of a mechanical laminate of materials is prepared by vacuum evaporation or ion sputtering for a consumer electronic apparatus, which entails high manufacturing cost.

In conventional techniques, solid-state welding processes may often be used for bonding veneer to cast metal part, such as cold welding, friction welding or ultrasonic welding or other solid state welding processes. However, such solid-state welding processes may significantly increase the complexity and the cost of the processing flow. Therefore, persons skilled in the art are still looking for an effective method for manufacturing a plate including multiple metal layers with lower cost and process complexity.

### SUMMARY OF THE INVENTION

The present invention aims to eliminate the problems with the prior art, and manufacture a plate including multiple metal layers at low cost and high yield, by preparing materials according to actual material consumption, thus being more environmental friendly and cost efficient than the technology currently available. Meanwhile, different metals of double layers or multiple layers may be designed to completely or partially cover a substrate, so as to meet the requirements for appearance and mechanical performance at the same time, which will save a large amount of work in developing different alloy materials and save global resources.

The method of the present invention achieves good joining, bonding or engaging strength between multiple metal layers and improves the metal compactness and the surface smoothness, and facilitates subsequent metal surface treatment.

An embodiment of the present invention provides a method of manufacturing a plate comprising multiple metal layers, which includes: disposing a semi-finished plate formed of a first metal in a mold, wherein a surface of the semi-finished plate is roughened; and injecting a second metal in liquid form onto the roughened surface of the semi-finished plate, so as to form a second metal layer on the semi-finished plate, wherein the second metal in liquid form covers and fills the roughened surface of the semi-finished plate.

Another embodiment of the present invention provides a method for manufacturing a plate including multiple metal layers, which includes: disposing a semi-finished plate formed of a first metal in a mold, wherein a surface of the semi-finished plate is provided with at least one engaging structure; and injecting a second metal in liquid form onto the surface of the semi-finished plate, so as to form a second metal layer on the semi-finished plate, wherein the second metal in liquid form covers and fills the at least one engaging structure on the surface of the semi-finished plate.

Yet another embodiment of the present invention provides a plate with multiple metal layers, which includes: a first metal layer, wherein a surface of the first metal layer is provided with at least one engaging structure; and a second metal layer engaging on the first metal layer by the at least one engaging structure.

### BRIEF DESCRIPTION OF THE DRAWING

FIG. 1 illustrates a method according to a preferred embodiment of the present invention;

FIG. 2-1 illustrates an open state of a device according to a preferred embodiment of the present invention;

FIG. 2-2 illustrates a closed state of a device according to a preferred embodiment of the present invention;

FIG. 2-3 is a partially enlarged view of FIG. 2-2;

FIG. 3 illustrates a method according to another preferred embodiment of the present invention; and

FIG. 4 illustrates a device according to another preferred embodiment of the present invention.

FIG. 5 illustrates a method according to a preferred embodiment of the present invention;

FIG. 6 illustrates a plate including multiple metal layers according to a preferred embodiment of the method shown in FIG. 5;

FIG. 7 illustrates a method according to another preferred embodiment of the present invention;

FIG. 8 illustrates a plate including multiple metal layers according to a preferred embodiment of the method shown in FIG. 7;

FIG. 9A illustrates a plate including multiple metal layers according to a preferred embodiment of the present invention;

FIG. 9B illustrates a plate including multiple metal layers according to another preferred embodiment of the present invention;

FIGS. 10A to 10C illustrate the process whereby a second metal in molten form is injected into a mold to bond or engage with a first metal layer; and

FIG. 11 is a sectional view illustrating an alternative mold suitable for use in a method according to the present invention.

### DETAILED DESCRIPTION OF THE INVENTION

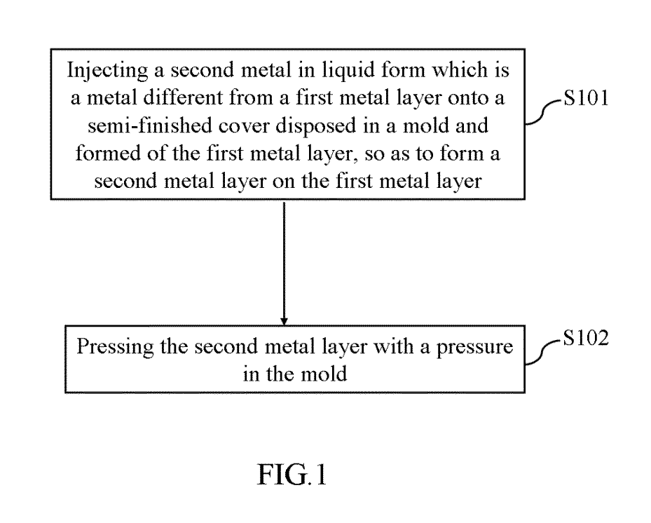

An embodiment of a method according to the present invention is shown in FIG. 1, and the method includes: injecting a second metal in liquid form which is a metal different from a first metal layer onto a semi-finished cover which is disposed in a mold and formed of the first metal layer, so as to form a second metal layer on the first metal layer (S101), and pressing the second metal layer with a pressure in the mold (S102). A third metal in liquid form may be injected onto the second metal to form a three-layer cover by repeating the operation.

The injection operation includes different aspects such as high-pressure injection molding, pouring or flowing. The pressure, the speed at which and the short time duration in which the second metal is injected into the mold help to improve the adhesiveness between the first metal layer and the second metal layer, remove bubbles in the second metal material in a liquid state, and improve the compactness of the second metal layer, so that no pore is left after cooling and curing of the second metal layer, thereby achieving the strength of a composite metal. This may also prevent the formation of a liquid flow mark due to flowing of the metal in liquid form during the injection of the second metal in liquid form. The process of pressing the second metal layer may also enable a surplus of the second metal in liquid form material to overflow.

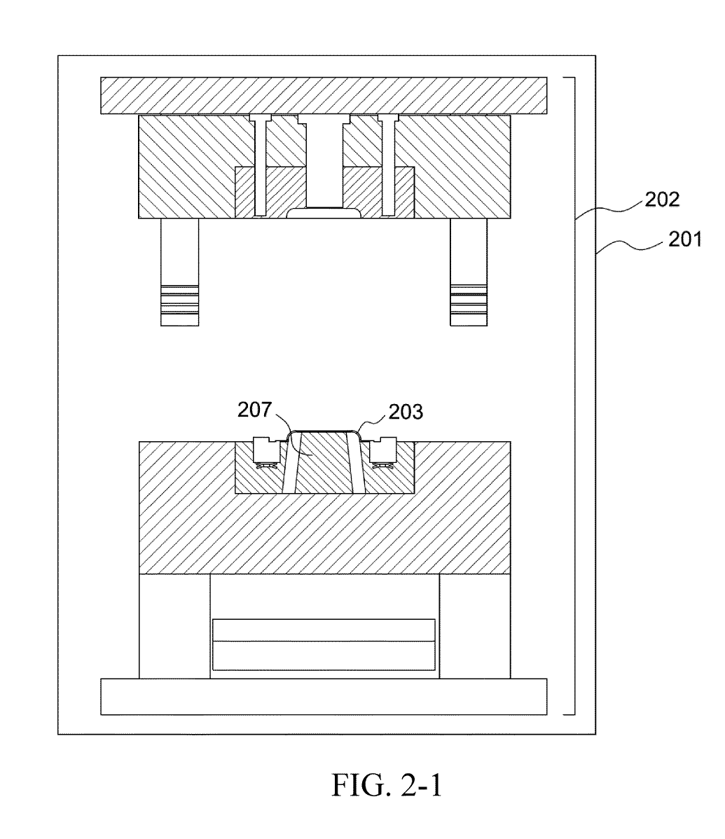

Another preferred embodiment of the present invention discloses a device for manufacturing a cover including multiple metal layers. FIG. 2-1 illustrates an open state of a device 201 according to a preferred embodiment of the present invention. The device 201 includes a mold 202, and a semi-finished cover (a first metal layer 203) formed of a first metal is disposed in the mold 202 (that is, on a rear mold 207). FIG. 2-2 illustrates a closed state of the device 201. In the closed state, a second metal in liquid form 2041 which is a different metal from the first metal layer 203 is injected onto the semi-finished cover disposed in the mold 202 and formed of the first metal layer 203, so as to form a second metal layer 204 on the first metal layer 203.

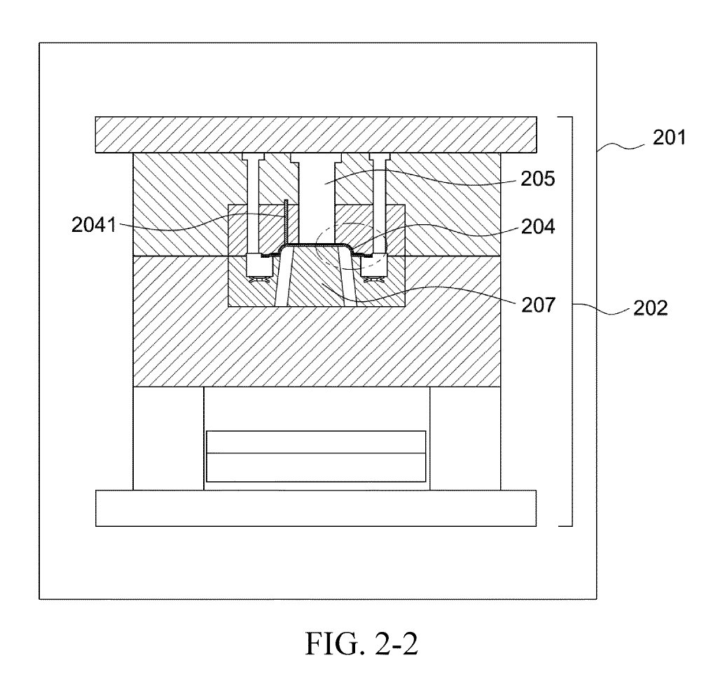

FIG. 2-3 is a partially enlarged view of FIG. 2-2. The mold 202 includes a pressing component 205, for applying a pressure to the second metal layer 204 located in the mold 202.

In a preferred embodiment, a reserved space is provided between the rear mold 207 and the pressing component 205, so that the second metal in liquid form 2041 may be injected into the reserved space. Moreover, the mold 202 may additionally include an overflow port 206, so that a surplus of the second metal in liquid form overflows through the overflow port 206 when the pressing component 205 presses the second metal layer 204.

Yet another preferred embodiment of the present invention relates to a method for manufacturing a cover including multiple metal layers. As shown in FIG. 3, the method of the present invention includes: injecting a first metal in liquid form into a space between a first front mold and a rear mold operating in cooperation with the first front mold, so as to form a first metal layer (S301); and in a second front mold operating in cooperation with the rear mold, injecting a second metal in liquid form onto the first metal layer in a semi-solid molten state, so as to form a second metal layer on the first metal layer (S302). A cover with three layers or more may also be formed in the same manner as required.

The difference from the method in FIG. 1 lies in that, when the first metal layer is in the semi-solid molten state, the second metal layer is formed thereon, which not only improves the adhesiveness between the first metal layer and the second metal layer, but also reduces cost and saves time, thereby improving the yield.

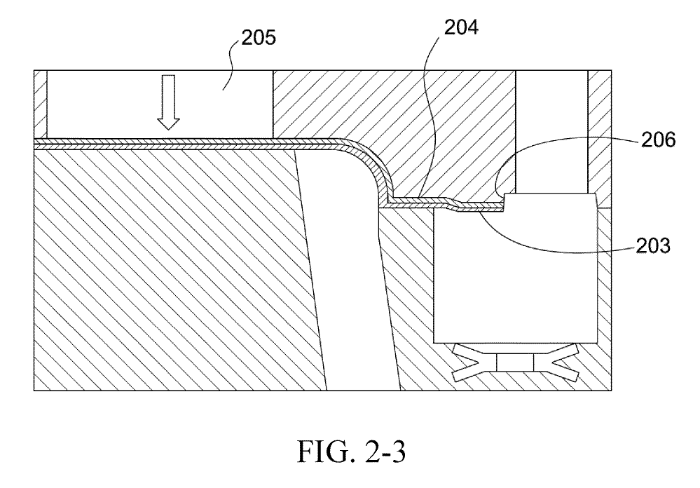

Yet another preferred embodiment of the present invention provides a device for implementing the method shown in FIG. 3. As shown in FIG. 4, a device 401 of this embodiment includes: a first front mold 402, capable of operating in cooperation with a rear mold 407 and used to inject a first metal in liquid form 4031, so as to form a first metal layer 403; and a second front mold 408, operating in cooperation with the rear mold 407 and used to inject a second metal in liquid form 4041 onto the first metal layer 403 in a semi-solid molten state, so as to form a second metal layer 404 on the first metal layer 403.

In yet another preferred embodiment of the present invention, when the second front mold 408 operates in cooperation with the rear mold 407, a reserved space is provided between the rear mold 407 and a pressing component 405, so that the second metal in liquid form may be injected into the reserved space.

Moreover, the pressing component 405 in the second front mold 408 may be used to apply a pressure to the second metal layer 404. Furthermore, the rear mold 407 further includes an overflow port 406, so that a surplus of the second metal in liquid form may overflow through the overflow port 406 when the pressing component 405 applies a pressure to the second metal layer 404.

In yet another preferred embodiment of the present invention, the device 401 further includes a movement component, for relatively moving the rear mold 407 between the first front mold 402 and the second front mold 408. For example, the rear mold 407 may be moved from the first front mold 402 to the second front mold 408 after the first metal in liquid form is injected; or the first front mold 402 is moved away after the first metal in liquid form is injected, and the second front mold 408 is moved to a position operating in cooperation with the rear mold 407, so as to inject the second metal in liquid form. Through this embodiment, the injection of both the first metal in liquid form and the second metal in liquid form is performed in the same device, which may make the procedure simpler.

According to the present invention, a metal cover with three layers or more may also be formed in the same manner as required.

In a preferred embodiment, the materials of the first metal layer and the second metal layer may be stainless steel, zinc, aluminum, magnesium, chromium, titanium, copper, beryllium, nickel or an alloy thereof, or other metals and alloys. The first metal layer with a small specific weight may first be formed, and then the second metal layer with a large specific weight is formed; or the first metal layer with a large specific weight may first be formed, and then the second metal layer with a small specific weight is formed. For example, if the first metal layer is formed of a zinc alloy, and the second metal layer is formed of an aluminum alloy, the strength of a composite metal may be achieved, and subsequent anodizing surface treatment may be performed on the second metal layer. In another example, the first metal layer is formed of an aluminum alloy or a magnesium alloy, and the second metal layer is formed of stainless steel, so that subsequent treatment such as direct current electroplating or vacuum evaporation may be conveniently performed on a surface of the second metal layer, thereby further forming a subsequent metal or non-metal layer.

Not only does the multi-layer metal cover manufactured according to the method of the present invention have the strength and elasticity of a composite metal, but also subsequent surface treatment may be performed on the metal cover as required, such as heat treatment, anodizing surface treatment, Galvanic plating, vacuum coating/film treatment, coating treatment, painting treatment, and corrosion resistant treatment, to further improve the adhesiveness between metal layers, the strength and the corrosion resistance, and make the design of the cover more flexible.

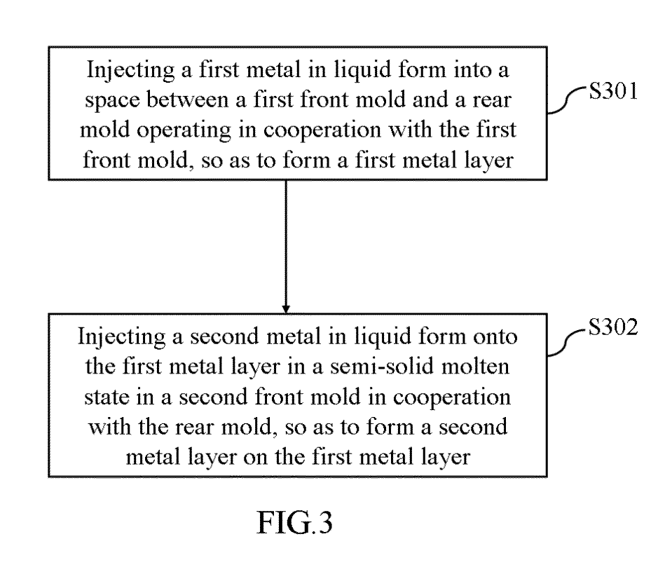

An embodiment of a method according to the present invention is shown in FIG. 5, and the method includes: disposing a semi-finished plate formed of a first metal layer in a mold, wherein a surface of the semi-finished plate is roughened (S501), and injecting a second metal in liquid form onto the roughened surface of the semi-finished plate, so as to form a second metal layer on the semi-finished plate, wherein the second metal in liquid form caps (or covers) and fills the roughened surface of the semi-finished plate (S502). In an embodiment, the roughened surface of the semi-finished plate can be formed on either cosmetic surface or inner surface of the semi-finished plate. A third metal in liquid form may be injected onto the second metal layer to form a three-layer plate by repeating the operation.

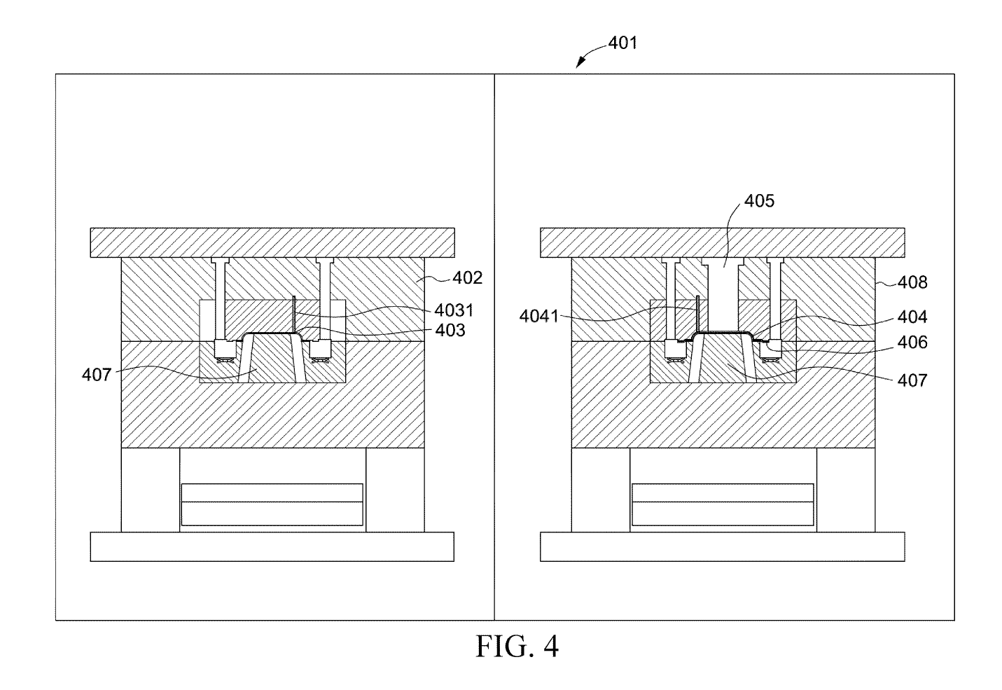

FIG. 6 illustrates a plate comprising multiple metal layers according to a preferred embodiment of the method shown in FIG. 5. As shown in FIG. 6, a semi-finished plate 612 is disposed in a mold 610 and formed of a first metal material. A surface of the semi-finished plate 612 is formed with a roughened surface 613. A second metal material in liquid form is injected or injection molded onto the roughened surface 613 of the semi-finished plate 612, to form a second metal layer 614 on the semi-finished plate 612 and sufficiently cap (or cover) and fill the roughened surface 613 of the semi-finished plate 612, so as to increase the adhesive strength between the semi-finished plate 612 and the second metal layer 614. In an embodiment, the semi-finished plate 612 and the second metal layer 614 can be made of the same material or different materials. For the purpose of this application, where the context allows, the terms “metal” and “metals” shall also include “alloys of metal” and “alloys of metals” respectively.

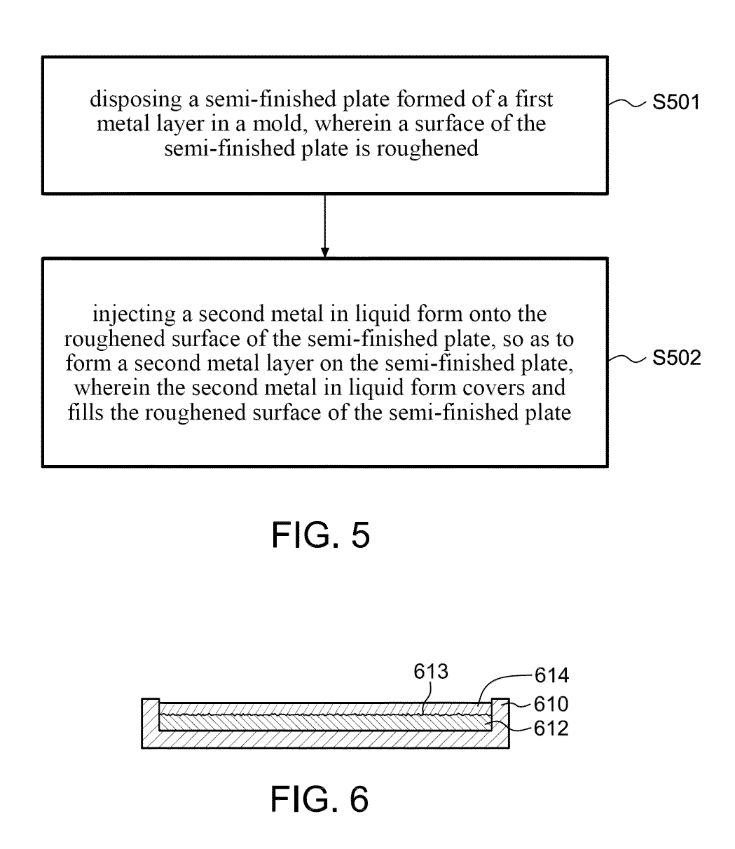

Another embodiment of a method according to the present invention is shown in FIG. 7, and the method includes: disposing a semi-finished plate formed of a first metal layer in a mold, wherein a surface of the semi-finished plate is provided with at least one engaging structure (S701), and injecting a second metal in liquid form onto the surface of the semi-finished plate, so as to form a second metal layer on the semi-finished plate, wherein the second metal in liquid form caps and fills the at least one engaging structure on the surface of the semi-finished plate (S702). In an embodiment, the engaging structure of the semi-finished plate can be formed on either cosmetic surface or inner surface of the semi-finished plate. A third metal in liquid form may be injected onto the second metal layer to form a three-layer plate by repeating the operation.

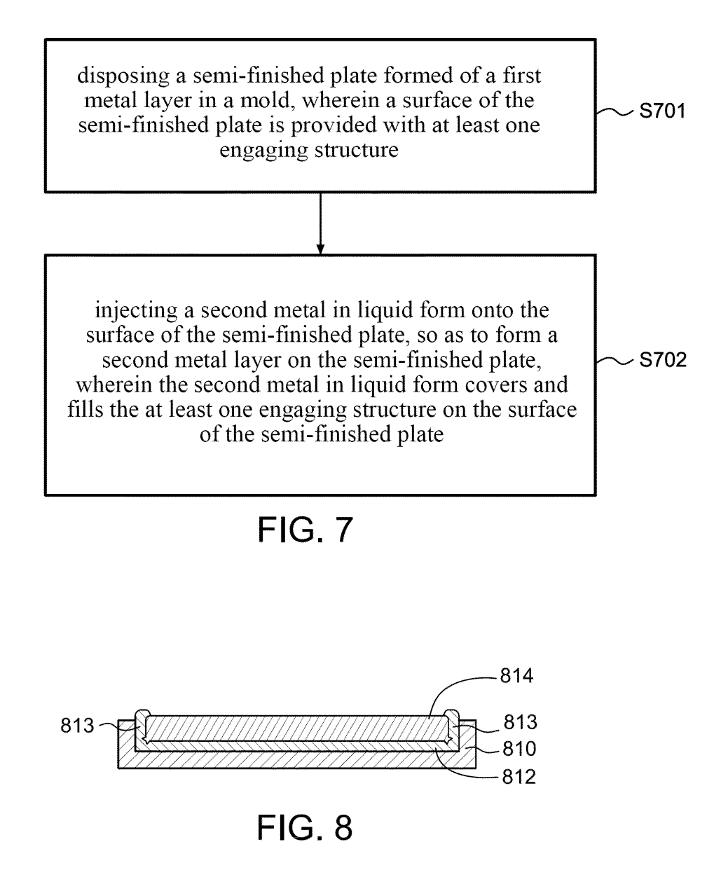

FIG. 8 illustrates a plate comprising multiple metal layers according to a preferred embodiment of the method shown in FIG. 7. As shown in FIG. 8, a semi-finished plate 812 is disposed in a mold 810 and formed of a first metal material. A surface of the semi-finished plate is formed with at least one engaging structure 813. The engaging structure 813 is formed by a hook, buckle, trench, protrusion or groove. A second metal in liquid form is injected or injection molded onto the surface of the semi-finished plate, to form a second metal layer 814 on the semi-finished plate 812 and sufficiently cap and fill the at least one engaging structure 813 on the surface of the semi-finished plate 812, whereby confining part of the second metal layer 814 to a space defined by the at least one engaging structure 813, so as to engage or fix the semi-finished plate 812 and the second metal layer 814.

In a preferred embodiment, the injecting the second metal in liquid form onto the surface of the semi-finished plate may be at a speed higher than (or equal to) 3 meters per second. The speed here may refer to the speed at which the second metal in liquid form exits the sprue and enters the runner or the like.

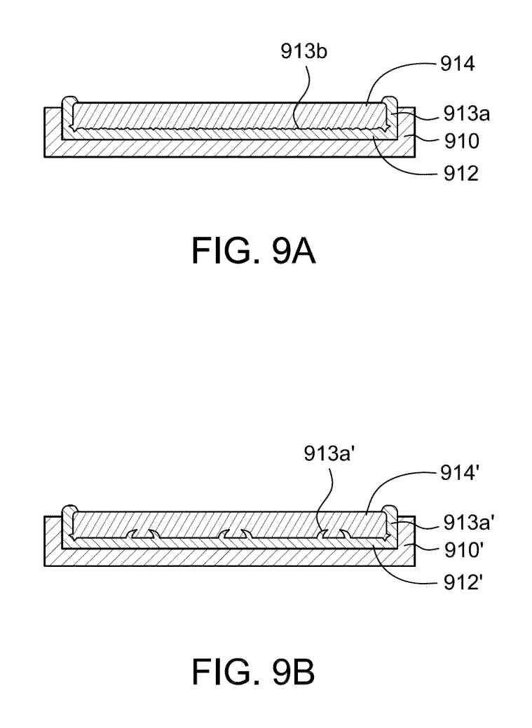

FIG. 9A illustrates a plate comprising multiple metal layers according to a preferred embodiment of the present invention. As shown in FIG. 9A, a semi-finished plate 912 is disposed in a mold 910 and formed of a first metal material. A surface of the semi-finished plate 912 is formed with a roughened surface 913b having a plurality of recesses, holes, grooves, balls or protrusions and at least one engaging structure 913a formed by a hook, buckle, trench, protrusion or groove. A second metal material in liquid form is injected or injection molded onto the roughened surface 913b and the at least one engaging structure 913a of the semi-finished plate 912 at a speed higher than (or equal to) 3 meters per second, to form a second metal layer 914 on the semi-finished plate 912 and sufficiently cap (or cover) and fill the roughened surface 913b and the at least one engaging structure 913a of the semi-finished plate 912, so as to increase the joining, bonding or engaging strength between the semi-finished plate 912 and the second metal layer 914 and confine the second metal layer 914 within a space defined by the engaging structure(s) 913a.

FIG. 9B illustrates a plate comprising multiple metal layers according to another preferred embodiment of the present invention. As shown in FIG. 9B, a semi-finished plate 912′ is disposed in a mold 910′ and formed of a first metal material. A surface of the semi-finished plate 912′ is formed with at least one engaging structure 913a′ formed by a hook, buckle, trench, protrusion or groove. A second metal material in liquid form is injected or injection molded onto the at least one engaging structure 913a′ of the semi-finished plate 912′ at a speed higher than (or equal to) 3 meters per second, to form a second metal layer 914′ on the semi-finished plate 912′ and sufficiently cap and fill the at least one engaging structure 913a′ of the semi-finished plate 912′, so as to increase the joining, bonding or engaging strength between the semi-finished plate 912′ and the second metal layer 914′ and confine the second metal layer 914 within a space defined by the engaging structure(s) 913a′. More particularly, bonding or engaging strength between the semi-finished plate 912′ and the second metal layer 914′ can be enhanced because the inter-engagement and/or interlocking between the second metal layer 914′ and the engaging structure 913a′ hinders detachment of the semi-finished plate 912′ and the second metal layer 914′ from each other.

In a preferred embodiment, the injecting the second metal in liquid form onto the roughened surface of the semi-finished plate may be at a speed higher than or equal to 3 meters per second.

In a preferred embodiment, the semi-finished plate (or the first metal layer) and the second metal layer may be made of the same material or different materials , and the material may comprise stainless steel, zinc, aluminum, magnesium, chromium, titanium, copper, beryllium, nickel or an alloy thereof.

In a preferred embodiment, the roughened surface of the semi-finished plate may be formed by a chemical manner, a mechanical manner or a combination of chemical manner and mechanical manner. For example, if the first metal layer is formed of aluminum (Al), we can use anodizing process to just built up porous (or a roughened surface) on the surface of first metal layer which is to be in joining with the molten second metal, the porous is for trapping the second metal in molten state. In other words, if the molten second metal (such as aluminum) is trapped into the porous, the second molten metal will be fastened on the first metal layer after the cooling and curing thereof.

In a preferred embodiment, the roughened surface of the semi-finished plate may be formed with a plurality of recesses, holes, grooves, balls or protrusions.

In a preferred embodiment, the at least one engaging structure on the surface of the semi-finished plate may be formed by a hook, buckle, trench, protrusion or groove.

In a preferred embodiment, the plate may be used to be a cover or an insert of an electronic device, or any other kinds of products/devices in other industries which the device need to have better joining, bonding or engaging strength on two-metal or multi-metal construction.

In a preferred embodiment, the first metal layer and the second metal layer may be engaged together by bonding or by confining a part of the second metal layer in a space defined by the engaging structure.

In above-mentioned methods, the second metal 614, 814, 914 and 914′ in liquid form may be injected or injection molded onto the surface of the semi-finished plate at a speed higher than 3, 3.5, 4.0, 4.5, 5.5, 6.0 or even 6.5 (and above) meters per second (m/s). In such a way, the second metal layer can be formed and shaped in an extremely thin dimension, to make the recesses, holes, grooves, balls or protrusions of the roughened surface and hook(s), buckle(s), trench(es), protrusion(s) or groove(s) of the engaging structure to be well capped (or covered) and filled by the second metal material. In a preferred embodiment, the thickness of the plate may be less than or equal to 0.3 mm (and even less than 0.2 or 0.1 mm) by adjusting the injection speed.

In view of the above, high speed is in a critical parameter for keeping the temperature of the molten material from the nozzle (or sprue) to the cavity. Localized melting on the surfaces of the two metals which is going to be joined or bonded together can only form a weak bonding, post-processes are needed, for examples, laser welding, resistance welding and some other welding processes which are known in the market. Purpose of the welding is for enhancing the joining or bonding strength between the two metals. In the present invention, we had considered the formation of the joining of the two metals, to provide a bolted locking mechanism (or bolted locking space) on the first metal layer, as described, it can be made by either only chemical method, or only mechanical method, or both chemical and mechanical methods, for guiding the second metal in molten state to be trapped by the designated space defined by the bolted locking mechanism, as the engaging structures 913a and 913a′ depicted in FIGS. 9A-9B.

For achieving the a better bolted locking/engagement between the two metals, only by applying pressure by means of plunger, or other kind of mechanical parts of the die-casting machines, or other injection machines, are not sufficient to push the semi-solid metal for having a good joining/bonding between the two metals.

Furthermore, high speed can keep the temperature as high as possible, from the nozzle (or sprue) to the cavity. Therefore, an extremely thin thickness of the second metal as the molten metal can be injected to the designated space by applying such a high speed, to achieve a thickness of the second metal less than or equal to 0.3 mm, even 0.2 and 0.1 mm or even thinner, depends on the design of product as 3D shape will become the major in the future.

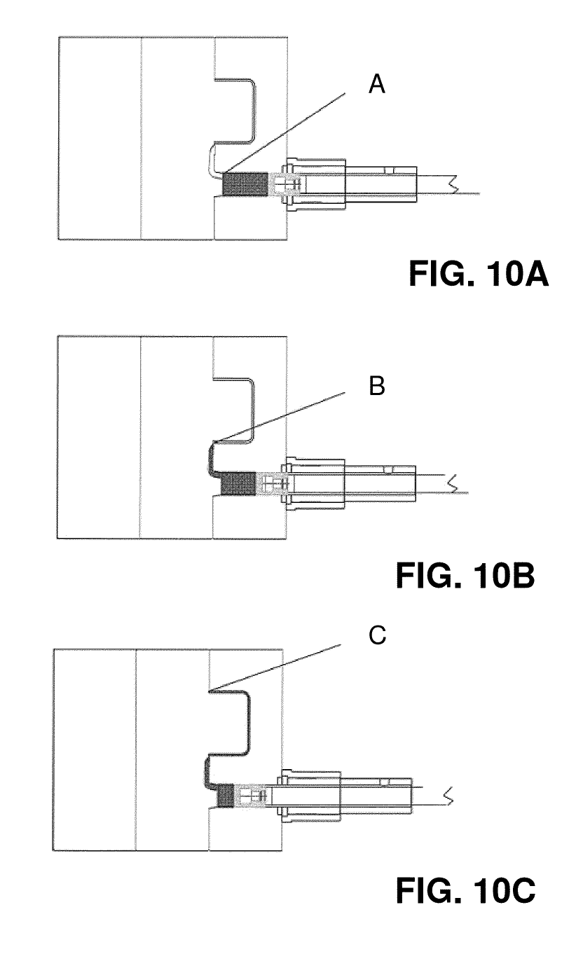

A purpose of injecting the second metal in liquid form into the mold at a high speed is to ensure that the second metal fills up the cavity in a very short time, and thus the second metal is still in the molten stage when it fills up the cavity to form the second metal layer. As shown in the example illustrated in FIGS. 10A to 10C, the total time duration starting from that shown in FIG. 10A (when the molten second metal exits the sprue and enters the runner, at point A), through that shown in FIG. 10B (when the molten second metal has passed through the runner and is about to enter the gate, at point B), until that shown in FIG. 10C (when the molten second metal fills up the cavity of the mold, at point C) is not more than 0.02 second., with a total displacement of 130 mm. Of this 0.02 second, the time duration which the molten second metal takes to fill up the cavity only is not more than 0.002 s. In this example, the speed at which the molten second metal exits the sprue and enters the runner is 3 m/s, and the speed at which the molten second metal enters the cavity of the mold is 60 m/s.

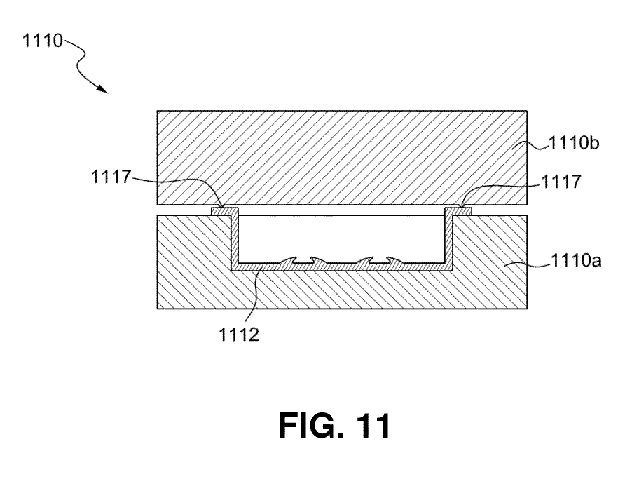

To further enhance the engagement and bonding strength between the two metal layers, as shown in FIG. 11, a mold 1110 for manufacturing a plate comprising multiple metal layers according to this invention has an upper mold 1110b with an endless barrier 1117 which extends away from a surface of the upper mold directly facing a lower mold 1110a. When the upper mold 1110b is in place relative to the lower mold 1110a and the first metal semi-finished plate 1112 ready for injection of the second metal in molten form into the mold, the barrier 1117 contacts and is pressed onto the semi-finished plate 1112 to enclose an air-tight cavity between the upper mold 1110b and the semi-finished plate 1112, which cavity being sealed off from the outside. The air-tight cavity reduces further oxidation of the molten second metal during its flow in the mold. Because of the high speed at which the second metal in molten form exits the sprue and enters the runner, and with the help of the air-tight cavity (which reduces further oxidation of the second metal in molten form), the molten second metal can engage with or penetrate into the roughened surface and/or the engagement element on the semi-finished plate 1112 in a very short period of time, say of no more than 0.002 s, to thereby enhance the strength of engagement between the two layers of metal. On the other hand, in the absence of the barrier, the surface tension of the oxidized molten second metal and/or semi-solid second metal will be higher, causing higher viscosity of the molten second metal, which will slow down the flow of the molten second metal. It will thus be difficult for the molten second metal to penetrate or engage with the engagement elements of the semi-finished plate 1112, in particular if such engagement elements are of a height of less than 0.5 mm and a width of less than 0.5 mm, or engagement elements of a depth of at least 0.5 mm.

As distinct from existing practice, there is no provision of exit through which excess material (i.e. the second metal) exits the mold cavity, and becomes burrs and flash to be trimmed off after the molding process. On the other hand, any excess second metal will, in the present method, flow over the first metal layer/plate and still forms part of the product.

Although FIG. 11 shows the barrier 1117 being provided by the upper mold 1110b, it is envisaged that, with proper design, the barrier 1117 may be provided by the lower mold, e.g. on a surface facing directly the upper mold.

A method according to this method possesses at least the following advantages:
(a) the molded product can be ejected after the injection molding process, which is different from the ordinary casting process in which the product has to be cooled down before it can be ejected from the cavity,
(b) the cooling rate of the molten second metal is reduced,
(c) further oxidation of the molten second metal is reduced before it is cooled down, thus allowing the molten second metal to fully engage with or penetrate into different parts of the roughened surface or engagement elements (such as grooves, pores, recesses) of the semi-finished plate, and
(d) as all the molten metal is trapped, with no overflow of such material, the edges around the first and second metal layers become dense and sealed. There is thus no gap between the metal layers, in particular the boundary or the joining line between the metal layers, which is observable by the end users. In addition to being a cosmetic treatment for the product, such also prevents liquid (such as water, DI water, acids, alkalis or the like) from seeping between the metal layers, thereby at least reducing the potential problem of galvanic corrosion of the product.

Although the technical contents and features of the present invention are described above, various variations and modifications can be made by persons of ordinary skill in the art without departing from the teaching and disclosure of the present invention. Therefore, the scope of the present invention is not limited to the disclosed embodiments, but encompasses other variations and modifications that do not depart from the present invention as defined by the appended claims.

What is claimed is:

1. A method for manufacturing a plate comprising multiple metal layers, comprising:
disposing a semi-finished plate formed of a first metal in a mold, wherein a surface of the semi-finished plate is roughened; and
injecting a second metal in liquid form onto the roughened surface of the semi- finished plate, so as to form a second metal layer on the semi-finished plate, wherein the second metal in liquid form covers and fills the roughened surface of the semi-finished plate.

2. The method according to claim 1, wherein the injecting the second metal in liquid form onto the roughened surface of the semi-finished plate is at a speed higher than or equal to 3 meters per second.

3. The method according to claim 1, wherein the injecting the second metal in liquid form onto the roughened surface of the semi-finished plate is at a speed higher than or equal to 6.5 meters per second.

4. The method according to claim 1, wherein the first metal layer and the second metal layer are made of the same material or different materials, and the material comprises stainless steel, zinc, aluminum, magnesium, chromium, titanium, copper, beryllium, nickel or an alloy thereof.

5. The method according to claim 1, wherein the roughened surface of the semi-finished plate is formed by a chemical manner, a mechanical manner or a combination of chemical manner and mechanical manner.

6. The method according to claim 1, wherein the roughened surface of the semi-finished plate is formed by a plurality of recesses, holes, grooves, balls or protrusions.

7. The method according to claim 1, wherein the plate is a cover or an insert of an electronic device.

8. A method for manufacturing a plate comprising multiple metal layers, comprising:
disposing a semi-finished plate formed of a first metal in a mold, wherein a surface of the semi-finished plate is provided with at least one engaging structure; and
injecting a second metal in liquid form onto the surface of the semi-finished plate, so as to form a second metal layer on the semi-finished plate, wherein the second metal in liquid form covers and fills the at least one engaging structure on the surface of the semi-finished plate.

9. The method according to claim 8, wherein the injecting the second metal in liquid form onto the surface of the semi-finished plate is at a speed higher than or equal to 3 meters per second.

10. The method according to claim 8, wherein the injecting the second metal in liquid form onto the surface of the semi-finished plate is at a speed higher than or equal to 6.5 meters per second.

11. The method according to claim 8, wherein the first metal layer and the second metal layer are made of the same material or different materials, and the material comprises stainless steel, zinc, aluminum, magnesium, chromium, titanium, copper, beryllium, nickel or an alloy thereof.

12. The method according to claim 8, wherein the at least one engaging structure on the surface of the semi-finished plate is formed by a chemical manner, a mechanical manner or a combination of chemical manner and mechanical manner.

13. The method according to claim 8, wherein the at least one engaging structure on the surface of the semi-finished plate is formed by a hook, buckle, trench, protrusion or groove.

14. The method according to claim 8, wherein the plate is a cover or an insert of an electronic device.

15. A plate with multiple metal layers, comprising:
a first metal layer, wherein a surface of the first metal layer is provided with at least one engaging structure; and
a second metal layer engaging on the first metal layer by the at least one engaging structure.

16. The plate according to claim 15, wherein the at least one engaging structure comprises recess, hole, groove, hook, buckle, trench, ball or protrusion.

17. The plate according to claim 15, the first metal layer and the second metal layer are made of the same material or different materials, and the material comprises stainless steel, zinc, aluminum, magnesium, chromium, titanium, copper, beryllium, nickel or an alloy thereof.

18. The plate according to claim 15, wherein the first metal layer and the second metal layer are engaged together by bonding or by confining the second metal layer in a space defined by the at least one engaging structure.

19. The plate according to claim 15, wherein the plate is a cover or an insert of an electronic device.

20. The plate according to claim 15, wherein a thickness of the plate is less than or equal to 0.3 mm.
